(19) United States
(12) Patent Application Publication
(10) Pub. No.: US 2017/0331414 A1
(43) Pub. Date: Nov. 16, 2017

(54) FEET OF SOLAR COLLECTOR SUPPORT STRUCTURES, JOINTS BETWEEN FEET OF SOLAR COLLECTOR SUPPORT STRUCTURES AND CONCRETE, AND METHODS OF FORMING THE SAME

(71) Applicant: Alion Energy, Inc., Richmond, CA (US)

(72) Inventors: Sean Bailey, Emeryville, CA (US); Adam French, San Francisco, CA (US); Rodney Hans Holland, Novato, CA (US); Tristan French, El Sobrante, CA (US); Christopher C. Caison, Castro Valley, CA (US); Mark Kingsley, Hollis, NH (US)

(21) Appl. No.: 15/595,753

(22) Filed: May 15, 2017

Related U.S. Application Data
(60) Provisional application No. 62/337,218, filed on May 16, 2016.
(60) Provisional application No. 62/359,959, filed on Jul. 8, 2016.

(51) Int. Cl. H02S 20/10

(52) U.S. Cl. CPC H02S 20/10

(57) ABSTRACT

A method for installing a solar collector can include slip-forming a concrete track including a groove; curing the concrete track; placing a foot of a support structure of a solar collector in the groove; and applying adhesive between the foot and groove. Curing the concrete track optionally can include maintaining wetness of the concrete track for a sufficient period of time after slip-forming the concrete track. The foot optionally can include at least one of an aperture and a tab, and the adhesive flows through the aperture or around the tab. A foot of a support structure of a solar collector also is provided. The foot can be configured to be inserted into a groove and comprising a back wall, a first side wall including a first side tab, a second side wall including a second side tab, a third side wall, a fourth side wall, and a bottom wall.

### CROSS-REFERENCE TO RELATED APPLICATIONS

This application claims the benefit of U.S. Provisional Patent Application No. 62/337,218, filed on May 16, 2016 and entitled “One or More Feet of Tracker, and U.S. Provisional Patent Application No. 62/359,959, filed on Jul. 8, 2016 and entitled “Systems and Methods for Assembly, Operation, and Maintenance of Photovoltaic Modules,” the entire contents of both of which are incorporated by reference herein.

### FIELD

This application relates to joining structures to concrete.

### BACKGROUND

An exemplary design factor for solar collectors, such as an array of photovoltaic modules, is wind loading. For example, if support structures for the solar collector are not properly secured in place, sufficiently high winds can damage the collector.

### SUMMARY

Provided herein are feet of solar collector support structures, joints between feet of solar collector support structures and concrete, and methods of forming the same.

Under one aspect, a method for installing a solar collector includes slip-forming a concrete track including a groove. The method also can include curing the concrete track. The method also can include placing a foot of a support structure of a solar collector in the groove, the foot including at least one of an aperture and a tab. The method also can include applying adhesive between the foot and the groove such that the adhesive flows through the aperture or around the tab.

In some configurations, the adhesive mechanically locks the foot of the support structure into the groove via the aperture or tab.

Additionally, or alternatively, the foot can include a back wall, a first side wall including the tab, a second side wall including a second tab, a third side wall, a fourth side wall, and a bottom wall. Optionally, an upper surface of the adhesive flows above the tab and the second tab.

Additionally, or alternatively, the foot includes a sheet having the aperture provided therethrough. The adhesive can be applied between a first side of the sheet and the groove; and the adhesive can flow through the aperture to a location between a second side of the sheet and the groove. Optionally, the foot further includes a chamber and a second aperture provided through the chamber; and the adhesive fills the chamber and flows through the second aperture to the second side of the sheet.

Additionally, or alternatively, curing the concrete track optionally can include maintaining wetness of the concrete track for a sufficient period of time after slip-forming the concrete track. In one example, said maintaining wetness optionally can include repeatedly spraying water on the concrete track or on a permeable blanket over the concrete track over the sufficient period of time. Additionally, or alternatively, said maintaining wetness optionally can include covering a surface of the concrete track with a vapor-impermeable membrane for the sufficient period of time. Additionally, or alternatively, said maintaining wetness optionally can include spraying the entire concrete track with a curing compound, the method further including removing residue from the curing compound from at least a portion of the groove at which the adhesive is to be applied. Additionally, or alternatively, the method further optionally can include applying a mask to at least a portion of the groove at which the adhesive is to be applied, and said maintaining wetness can include spraying the concrete track with the mask applied thereto with a first curing compound; removing the mask to expose at least the portion of the groove; and spraying the exposed at least the portion of the groove with a second curing compound.

Optionally, the sufficient period of time is four to seven days. Additionally, or alternatively, the concrete track includes a first track including the groove and a second track including a second groove, the first and second tracks being parallel to one another in spaced relation. Optionally, the method further includes installing control joints along the concrete track.

Under another aspect, a foot of a support structure of a solar collector is configured to be inserted into a groove and includes a back wall, a first side wall including a first side tab, a second side wall including a second side tab, a third side wall, a fourth side wall, and a bottom wall.

Optionally, the back wall, the first side wall including the first side tab, the second side wall including the second side tab, the third side wall, the fourth side wall, and the bottom wall are integrally formed with one another. Optionally, respective cutouts are formed between one or more of the first side wall and the fourth side wall, the first side wall and the bottom wall, the second side wall and the bottom wall, the second side wall and the third side wall. Additionally, or alternatively, respective cutouts optionally are formed providing the first side tab within the first side wall and the second side tab within the second side wall. Additionally, or alternatively, the first, second, third, and fourth side walls and the bottom wall optionally each are disposed at an angle of about 90 degrees relative to the back wall. Additionally, or alternatively, the first side wall optionally is disposed at a first angle relative to the bottom wall, and the second side wall is disposed at a second angle relative to the bottom wall, wherein the first and second angles are different than one another.

Under yet another aspect, a foot of a support structure of a solar collector, the foot configured to be inserted into a groove and including a sheet including a lower edge and first and second ends, a chamber, a first plurality of apertures through the sheet, and tabs disposed at the first and second ends. Optionally, the sheet, chamber, and tabs are integrally formed with one another.

Under still another aspect, method for installing a solar collector includes slip-forming a concrete track including a groove. The method also can include curing the concrete track, wherein curing the concrete track includes maintaining wetness of the concrete track for a sufficient period of time after slip-forming the concrete track. The method also can include placing a foot of a support structure of a solar collector in the groove. The method also can include applying adhesive between the foot and the groove such that the adhesive surrounds the foot.

Optionally, said maintaining wetness includes repeatedly spraying water on the concrete track or on a permeable blanket over the concrete track over the sufficient period of time. Additionally, or alternatively, said maintaining wetness optionally includes covering a surface of the concrete track with a vapor-impermeable membrane for the sufficient period of time. Additionally, or alternatively, said maintaining wetness optionally includes spraying the entire concrete track with a curing compound, and the method further can include removing residue from the curing compound from at least a portion of the groove at which the adhesive is to be applied. Additionally, or alternatively, the method optionally further can include applying a mask to at least a portion of the groove at which the adhesive is to be applied, and said maintaining wetness can include spraying the concrete track with the mask applied thereto with a first curing compound; removing the mask to expose at least the portion of the groove; and spraying the exposed at least the portion of the groove with a second curing compound.

Additionally, or alternatively, the sufficient period of time optionally is four to seven days. Additionally, or alternatively, the concrete track can include a first track including the groove and a second track including a second groove, the first and second tracks being parallel to one another in spaced relation. Additionally, or alternatively, the method optionally can include installing control joints along the concrete track.

Under still another aspect, a joint is provided that includes a foot of a solar collector, the foot comprising at least one of an aperture and a tab. The joint also can include a concrete track comprising a groove, the foot being disposed in the groove. The joint also can include adhesive disposed between the foot and the groove such that the adhesive extends through the aperture or around the tab.

Optionally, the adhesive mechanically locks the foot of the support structure into the groove via the aperture or tab. Additionally, or alternatively, the foot can include a back wall, a first side wall including the tab, a second side wall including a second tab, a third side wall, a fourth side wall, and a bottom wall. Additionally, or alternatively, the foot can include a sheet including a lower edge and first and second ends, a chamber, a first plurality of apertures through the sheet, and tabs disposed at the first and second ends. The joint optionally can be formed using any of the methods provided herein.

Additionally, or alternatively, in any of the methods, feet, and joints provided herein, the adhesive optionally is colored so as to facilitate confirmation as to whether the adhesive completely surrounds the foot.

### BRIEF DESCRIPTION OF DRAWINGS

FIG. 1 schematically illustrates an exemplary configuration of a fixed-tilt solar collector.

FIG. 2 schematically illustrates an exemplary configuration of a foot of a solar collector support structure such as can be used in the configuration of FIG. 1.

FIG. 3 schematically illustrates an exemplary configuration of a joint between concrete in the solar collector of FIG. 1 and the foot of FIG. 2.

FIGS. 4A-4C schematically illustrate a flow of steps in an exemplary method for installing a solar collector such as illustrated in FIG. 1.

FIG. 5 schematically illustrates an exemplary configuration of a tracking solar collector.

FIG. 6 schematically illustrates an exemplary configuration of a foot of a solar collector support structure such as can be used in the configuration of FIG. 5.

FIG. 7 schematically illustrates an exemplary configuration of a joint between concrete in the solar collector of FIG. 5 and the foot of FIG. 6.

FIG. 8 schematically illustrates an exemplary configuration of an alternative foot of a solar collector support structure such as can be used in the configuration of FIG. 5.

FIGS. 9-10 schematically illustrate an exemplary configuration of a joint between concrete in the solar collector of FIG. 5 and the foot of FIG. 8.

FIGS. 11A-11E schematically illustrate cross-sections of different exemplary concrete groove configurations.

FIG. 12 illustrates an exemplary flow of steps in a method for installing a solar collector on a concrete track.

FIGS. 13-20 and 22 illustrate exemplary flows of steps in different methods for curing concrete.

FIG. 21 schematically illustrates an exemplary mask that can be used during the method of FIG. 20.

### DETAILED DESCRIPTION

Provided herein are feet of solar collector support structures, joints between feet of solar collector support structures and concrete, and methods of forming the same.

For example, one way to secure a solar collector in place is by using a mass of concrete as a ballast and then suitably securing the solar collector to the concrete at a joint. Another useful feature for solar collectors is to provide tracks that vehicles or machines can drive on to navigate large fields of solar collectors. Such machines can be used to assist in field assembly, panel cleaning, maintenance tasks, and/or diagnostics of the solar collectors. Slip-forming concrete is one way to efficiently make concrete structures that can serve both as an efficient ballast and also as a track for driving machines. The track can be, or include, structural plain concrete or reinforced concrete. Adhesives, such as construction epoxies, can be used to secure a solar collector's support structure onto the concrete surfaces at a joint. As provided herein, the loads on these joints can be reduced with careful design of the solar collector, and the joints can be designed for sufficient strength and durability. The resulting arrangement can be used in a wide variety of solar collector designs, including stationary solar collectors and tracking solar collectors, and can include a concrete structure suitable for use as both a ballast to address wind loads and as a track for vehicles.

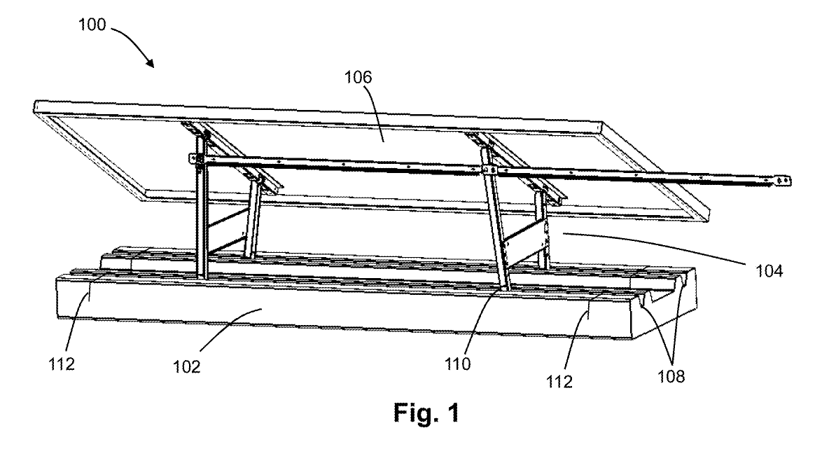

For example, FIG. 1 schematically illustrates an exemplary configuration of a fixed-tilt solar collector. Fixed-tilt solar collector 100 illustrated in FIG. 1 includes a concrete track 102, a support structure 104, and a photovoltaic panel 106. Photovoltaic modules 106 respectively can be coupled to support structures 104 that are adhered to the concrete track 102 as one next to another for the entire length of the concrete track.

In the nonlimiting configuration illustrated in FIG. 1, the concrete track 102 includes a unitary structure including grooves 108, e.g., two grooves each configured so as to receive a plurality of feet of support structure 104 such as described in greater detail elsewhere herein. Alternatively, concrete track 102 can include two separate concrete tracks that are arranged parallel to one another in spaced relation, each track including one or more grooves 108. The concrete track 102 can be formed using any suitable manufacturing method, such as slip forming or extrusion. The concrete track 102 can also be formed with a series of pre-cast blocks or by casting concrete in place. The concrete track 102 can have any suitable length. For example, the concrete track 102 can be relatively short, perhaps only a few meters long and supporting one photovoltaic panel 106 or a plurality of photovoltaic panels 106, or the concrete track 102 can be relatively long, perhaps a kilometer long or longer and supporting dozens or even hundreds of photovoltaic panels 106. The concrete track 102 can include plain concrete or can be reinforced, e.g., can include concrete surrounding reinforcing bar, or can include concrete mixed with reinforcing fibers, such as plastic, glass, and/or minerals of suitable dimensions so as to enhance the strength and durability of concrete track 102. Optionally, control joints 112 can be cut in the track 102 on a periodic spacing at an appropriate time in the construction process, e.g., can be cut into slip formed concrete. These optional control joints 112 can be cut so as to associate a sufficient amount of ballast with each foot of the support structure 104 and so as to inhibit or prevent cracks in track 102 at locations away from the control joints 112.

The support structure 104 can include any suitable number of feet 110 configured so as to support module 106, e.g., four feet 110 per module, or two feet 110 per module, or any other suitable number of feet. Feet 110 can be configured so as to be inserted into and stand in grooves 108. As provided herein, feet 110 can be adhered to the grooves 108 with an adhesive, such as a construction epoxy. Optionally, the adhesive can be colored so as to facilitate confirmation as to whether the adhesive completely surrounds each of feet 110. For example, the adhesive can be mixed with a dye that imparts sufficient color to the adhesive that it readily can be determined whether adhesive within the grooves sufficiently surrounds appropriate component(s) each of feet 110. In the nonlimiting configuration illustrated in FIG. 1, support structure 104 can have a “fixed tilt” configuration in which the angle of module 106 is substantially fixed relative to the ground. In other configurations, the support structure can have a “tracking” configuration such that the angle of module 106 can be varied, for example to track the sun over the course of a day. Support structure 104 can include any suitable combination of materials, including but not limited to metal, plastic (such as fiber-reinforced plastic), synthetic wood, or natural or treated wood.

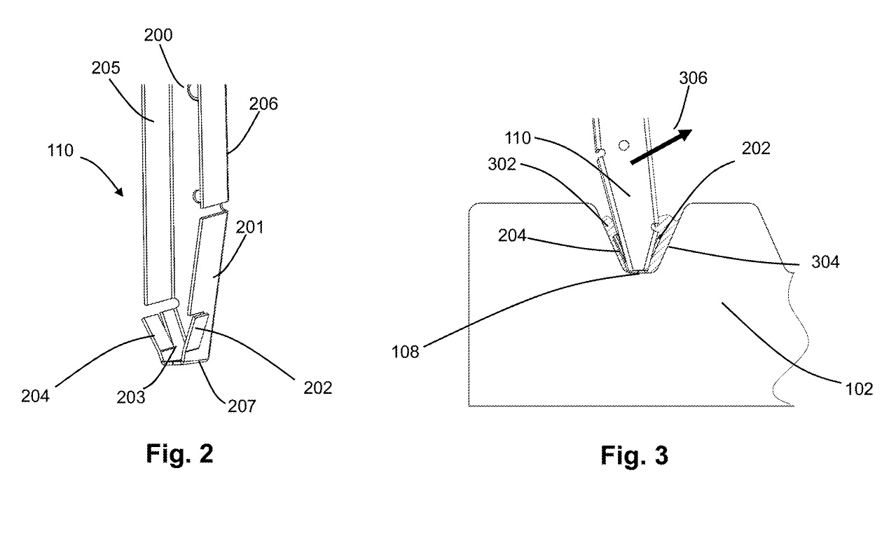

A foot of a solar collector, such as a fixed tilt configuration such as illustrated in FIG. 1, can have any suitable configuration. For example, as described in greater detail herein with reference to FIGS. 2-4, a foot of a support structure of a solar collector can be configured to be inserted into a groove and can include a back wall, a first side wall including a first side tab, a second side wall including a second side tab, a third side wall, a fourth side wall, and a bottom wall. The back wall, the first side wall including the first side tab, the second side wall including the second side tab, the third side wall, the fourth side wall, and the bottom wall can be integrally formed with one another. Respective cutouts can be formed between one or more of the first side wall and the fourth side wall, the first side wall and the bottom wall, the second side wall and the bottom wall, the second side wall and the third side wall. Additionally, or alternatively, respective cutouts can be formed providing the first side tab within the first side wall and the second side tab within the second side wall. The first, second, third, and fourth side walls and the bottom wall each can be disposed at an angle of about 90 degrees relative to the back wall. Additionally, or alternatively, the first side wall can be disposed at a first angle relative to the bottom wall, and the second side wall is disposed at a second angle relative to the bottom wall, wherein the first and second angles are different than one another.

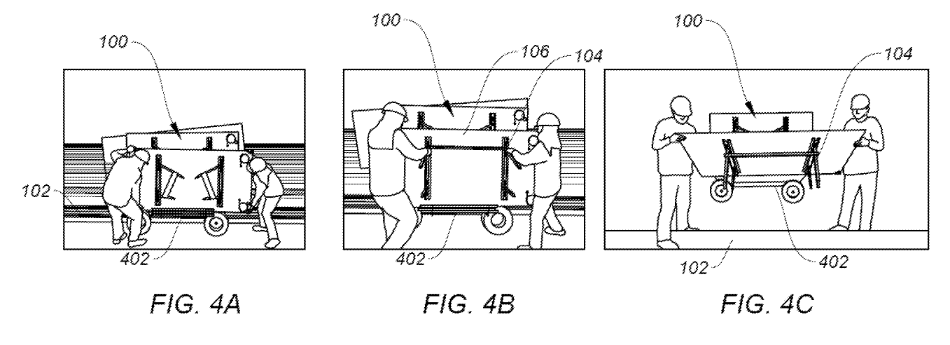

For example, FIG. 2 schematically illustrates an exemplary configuration of a foot 110 of a solar collector support structure 100 such as can be used in the configuration of FIG. 1. The foot 110 can be provided as part of support structure 104 and can be configured so as to be inserted into, and stand in, a groove 108 provided within a concrete track 102, such as illustrated in FIG. 1. The foot 110 can be configured so that an adhesive can secure the foot to the concrete of the track 102 within the groove 108, e.g., in a manner such as described herein with reference to FIG. 3. Foot 110 includes back wall 200, first side wall 201 including first side tab 202, second side wall 203 including second side tab 204, third side wall 205, fourth side wall 206, and bottom wall 207, which in some configurations can be integrally formed with one another. For example, a flat sheet of metal or other suitable material can be shaped, e.g., stamped, cut, molded, or otherwise shaped so as to define respective cutouts between one or more of first side wall 201 and fourth side wall 206, between first side wall 201 and bottom wall 207, between second side wall 203 and bottom wall 207, and between second side wall 203 and third side wall 205. Additionally, the sheet of metal or other suitable material can be shaped so as to define respective cutouts providing first side tab 202 within first side wall 201 and second side tab 204 within second side wall 203.

In some configurations, the first, second, third, and fourth side walls 201, 203, 205, 206, first and second tabs 202, 204, and bottom wall 207 can be provided by bending the metal or other suitable material at a suitable angle relative to back wall 200 and relative to other elements of foot 110. For example, in one nonlimiting configuration, first, second, third, and fourth side walls 201, 203, 205, 206 and bottom wall 207 each can be disposed at an angle of about 90 degrees relative to back wall 200. Additionally, or alternatively, first side wall 201 can be disposed at a first angle relative to bottom wall 207, and second side wall 203 can be disposed at a second angle relative to bottom wall 207, where the first and second angles are similar or different than one another. The first and second angles independently can be at an angle between about 45 degrees to about 90 degrees relative to the bottom wall 207. Additionally, or alternatively, first side wall 201 can be disposed relative to fourth side wall 206 at an obtuse angle (e.g., an angle between about 135 degrees to about 180 degrees.) Additionally, or alternatively, second side wall 203 can be disposed relative to third side wall 205 at an obtuse angle (e.g., an angle between about 135 degrees to about 180 degrees.) Additionally, or alternatively, first tab 202 can be disposed relative to first side wall 201 at an outward directed acute angle (e.g., an angle between about 2 degrees to about 45 degrees). Additionally, or alternatively, second tab 204 can be disposed relative to second side wall 203 at an outward directed acute angle (e.g., an angle between about 2 degrees to about 45 degrees). As such, tabs 202 and 204 respectively can be integrally formed with first and second walls 201, 203 and respectively flared outward and upward relative to first and second walls 201, 203 and relative to bottom 207. These tabs 202, 204 can be configured so as to increase the strength and durability of the joint between the adhesive and foot 110 within the groove.

For example, FIG. 3 schematically illustrates an exemplary configuration of a joint between concrete in the solar collector of FIG. 1 and the foot of FIG. 2. In the configuration illustrated in FIG. 3, the foot 110 is inserted into and stands in a groove 108 of track 102 that is wider than the foot 110, e.g., that has a width of between about 105% and about 200% of a width of foot 110. The groove 108 includes a wall on each side 304 such that groove 108 is tapered with a substantially flat bottom. For example, the walls 304 each can be angled relative to the substantially flat bottom, e.g., at an angle of about 45 degrees to about 90 degrees relative to the bottom.

In the configuration illustrated in FIG. 3, adhesive 302 surrounds the foot 110 and fills the width of the groove 108. The adhesive 302 can be, or include, for example, a construction epoxy or another type of adhesive. The adhesive 302 fills the groove 108 in the vicinity of the foot 110 to a level that is higher than the respective tops of the first and second tabs 202, 204. Filling the space between the groove walls 304 and the foot (e.g., between the groove walls 304, the first side wall 201, and the lower portion of second side wall 203 and optionally also between bottom wall 207 and the bottom of the groove) can provide for a stronger joint than, for example, locating the adhesive in the bottom of the groove under only the bottom wall 207 of the foot. Additionally, or alternatively, the arrangement of foot, groove, and adhesive such as illustrated in FIG. 3 can enhance the strength of the joint relative to a configuration lacking flared tabs 202, 204. For example, the adhesive 302 can form a continuous or substantially continuous mass extending from walls 304 of the concrete groove 108 to the body of the foot 110 with an upper surface that extends above the flared tabs 202, 204 on each side of the foot. Such mass of adhesive 302 can provide a mechanical lock the foot 110 so that the adhesive would have to crack and structurally fail for the foot (and in particular the tabs 202, 204) to come loose before the concrete fails. Such a lock can be significantly stronger than if the adhesive 302 was only chemically bonded to the surface of the foot, such that the adhesive would only have to de-bond from the surface of the foot for failure to occur. Furthermore, with the nonlimiting arrangement in FIG. 3, an upward and lateral pulling force 306 on the foot 110 can result in shear and tension in the concrete and adhesive. However, encapsulation of the foot 110 in the groove 108 by adhesive 302 can reduce or eliminate peeling force between the foot and adhesive. Concrete compression capacity is an order of magnitude higher than its tension capacity. Also, in this nonlimiting arrangement, the concrete compression capacity can be evaluated using standard cone pullout models.

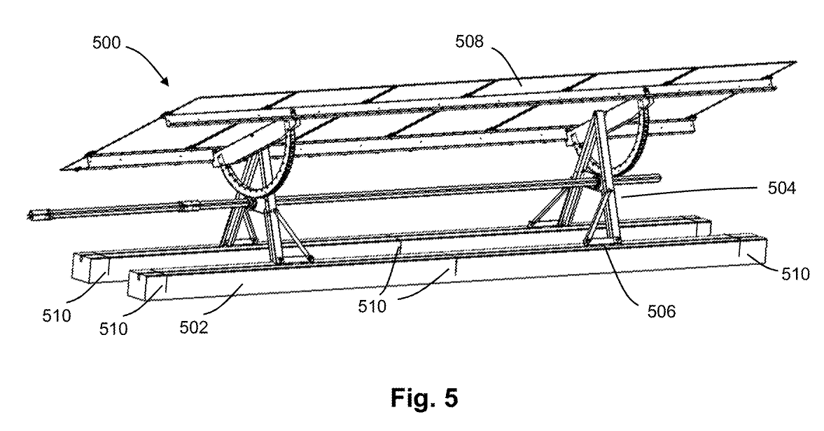

There are many ways to assemble a solar collector to locate the feet 108 in the concrete grooves 102. For example, FIGS. 4A-4C schematically illustrate a flow of steps in an exemplary method for installing a solar collector 100 such as illustrated in FIG. 1. In FIG. 4A, workers position a cart 402 next to the location at which the solar collector 100 is to be installed. This cart can be designed to travel over an adjacent concrete track 102 where solar collectors 100 have not yet been installed. The cart 402 can be pulled by hand, by lightweight vehicle, by a full automobile or truck, or by other means such as by a work animal. In FIG. 4B, the workers can unfold the structure 104 while the solar collector 100 is on the cart 402. Then, in FIG. 4C, the workers lift the solar collector 100 off of the cart 402 and onto the concrete track 402. Once the solar collector 100 is placed on the concrete track 102, adhesive 304 is applied to secure the feet 110 to the concrete 102.

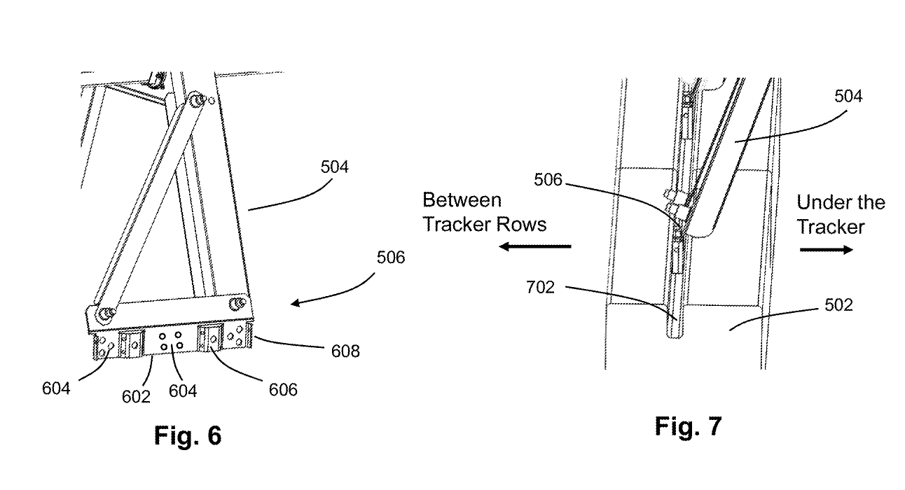

FIG. 5 schematically illustrates an exemplary configuration of a solar collector in which the panels track the sun about one axis, which can be referred to as solar tracker 500. In the nonlimiting configuration illustrated in FIG. 5, the solar tracker 500 includes two concrete tracks 502 and two A-frame support structures 504 mounted on the concrete tracks. Feet 506 are located on the bottoms of the support structure 504 at the attachment point to the concrete tracks 502. A series of structural elements and drive elements can be mounted on the A-frame support structures 504 and configured so as to rotate solar panels 508. Control joints 510 can be positioned along each concrete track in a manner similar to that described above with reference to FIG. 1. Note that FIG. 5 illustrates one of many ways to design a solar tracker for concrete ballast, and is not intended to be limiting.

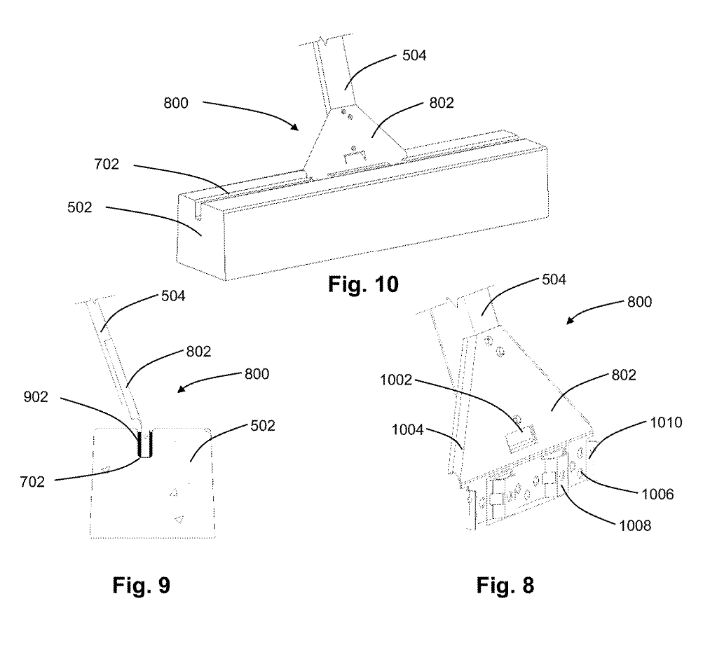

The foot of a solar collector, such as a solar tracker such as illustrated in FIG. 5, can have any suitable configuration. For example, in one configuration a foot of a support structure of a solar collector can be configured to be inserted into a groove. The foot can include a sheet including a lower edge and first and second ends, a chamber, a first plurality of apertures through the sheet, and tabs disposed at the first and second ends, e.g., such as described herein with reference to FIGS. 6-8. Optionally, the sheet, chamber, and tabs can be integrally formed with one another.

For example, FIG. 6 schematically illustrates an exemplary configuration of a foot 506 of a solar collector support structure such as can be used in the configuration of FIG. 5. Similarly as with the foot 110 described above with reference to FIGS. 2-3, the tracker foot 506 can be configured so as to mechanically engage the adhesive between it and the groove of concrete ballast 502 into which foot 506 is inserted, which is illustrated in FIG. 5. Foot 506 also is configured so as to facilitate fast and easy adhesive application through the chambers. In one configuration, the tracker foot 506 can be attached to the support frame leg 504 in a manner such as illustrated in FIG. 6. The foot 506 can be formed of a piece of sheet metal 602 or other suitable material, oriented horizontally with an edge downward. This sheet piece 602 can include multiple groupings of holes 604 and/or can include multiple chambers 606 that can be formed by bending a section of the sheet outward away from the plane of the sheet piece. The foot 506 also includes angled deformations (such as tabs) 608 on one or both ends. The deformations 608, chambers 606, and holes 604 in the foot 506 can mechanically lock the foot to the adhesive.

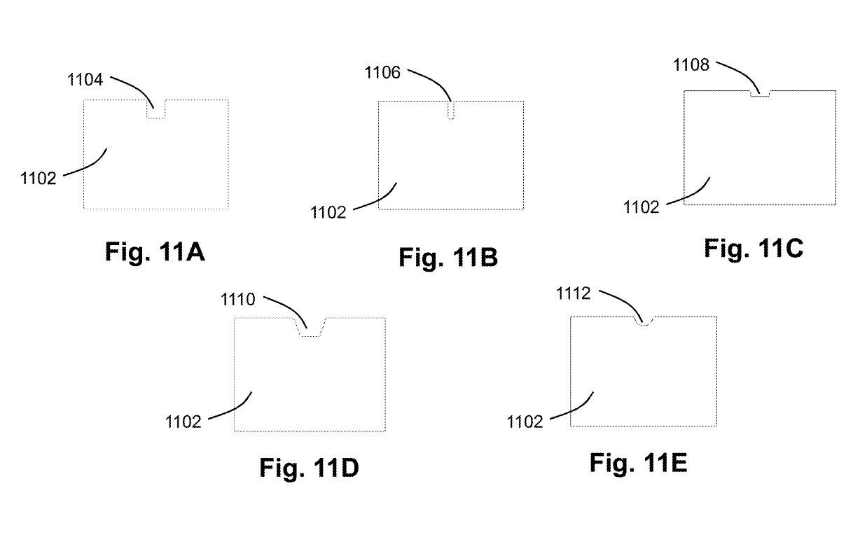

For example, FIG. 7 schematically illustrates an exemplary configuration of a joint between concrete in the solar collector of FIG. 5 and the foot of FIG. 6. FIG. 7 shows a top view of the tracker foot 506 located in the concrete ballast 502. The sheet piece 602 of the tracker foot 506 can be disposed in a narrow groove 702 in the concrete ballast 502, and can be fixed in place by an adhesive in a manner similar to that described above with reference to FIG. 3, which adhesive can be or include a structural epoxy or any other suitable kind of adhesive. The adhesive can be deposited on the foot 506 and in the groove 702. The adhesive can flow through the holes in the part 604 and/or into the chambers 606 that are illustrated in FIG. 6. The angled deformations (such as tabs) 608 provide further surfaces for the adhesive to bond to, and can inhibit or prevent the adhesive from spilling past the ends of the feet, thus reducing wasted adhesive. The holes and chambers can allow the adhesive to form a continuous mass from one side of the concrete groove 702 to the other, passing through the foot piece 602 and adhering to both sides of the groove 702. Similarly as in the foot design in FIGS. 2 and 3, such continuous mass can allow the adhesive to form a mechanical lock on the foot 506, which is much stronger than simply chemically adhering to the surfaces of the parts. For the joint to fail prior to concrete rupture, the adhesive must fracture rather than simply de-bonding from the surface of the part. In some configurations, the adhesive can be deposited on one side of the foot 506 within the groove, and the adhesive can flow through the holes to the other side of the groove. Depositing adhesive in the chambers 606 can also deposit the adhesive to the other side of the foot 506. As such, in the configuration illustrated in FIG. 7, the adhesive can be deposited relatively efficiently and quickly from the outside of the tracker. For example, a worker need not necessarily perform a potentially awkward and time-consuming maneuver to reach under the tracker to deposit adhesive to the backside of the foot 506.

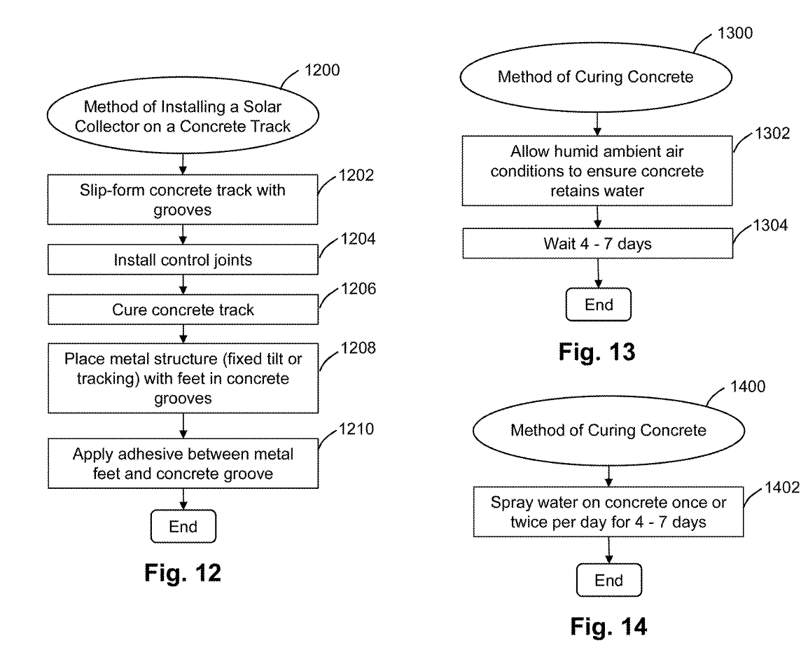

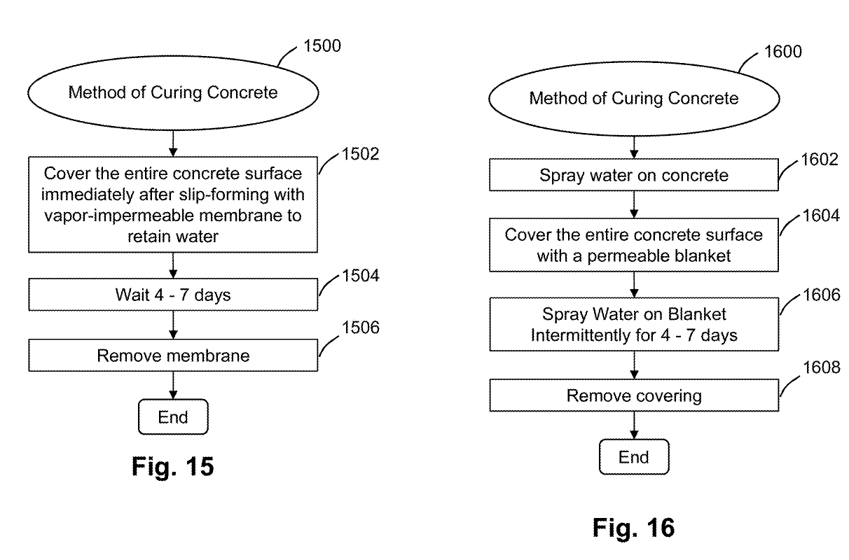

FIG. 8 schematically illustrates an exemplary configuration of an alternative foot of a solar collector support structure such as can be used in the configuration of FIG. 5, and FIGS. 9-10 schematically illustrate an exemplary configuration of a joint between concrete in the solar collector of FIG. 5 and the foot of FIG. 8. The connection between foot 800 and the concrete 502 can be similar to that illustrated in FIG. 6, but the connection to the tracker frame can be different. For example, FIG. 8 illustrates a configuration including a concrete base 502 and a tracker foot 800. The concrete base 502 includes a groove 702. The tracker foot 800 can include a foot plate 802 which can be connected to a support structure, e.g., support structure 104 described above with reference to FIG. 1 or tracker leg 504 described above with reference to FIG. 6. The tracker foot plate 802 and leg 504 both can be or include metal parts such as folded sheet metal, and can be fastened together with bolts, rivets, screws, blind structural fasteners, or any number of other fasteners. As illustrated in FIGS. 9-10, the tracker foot plate 802 can stand in the groove 702 in the concrete base 502 and can be fastened in place with an adhesive. FIG. 9 shows a cross-sectional view of the tracker foot 800 standing in the groove 702 and adhered to the concrete base 502. In this configuration, the adhesive 902 can be located between the groove walls 702 and the foot plate 802, on both sides of the foot plate 802.

FIG. 8 shows a detailed view of a nonlimiting configuration of the tracker foot 800. The tracker foot plate 802 can include a tab 1002. The tab 1002 can act as a stop so that the foot plate 802 can be slid quickly onto the leg 504 to a uniform location for assembly. The foot plate 802 can include folds 1004 in the sheet on each side so as to increase part stiffness. The foot plate 802 can include any suitable combination of features configured so as to improve adhesion to the concrete and to allow relatively quick and efficient assembly similar to the tracker foot configuration described above with reference to FIG. 6. For example, sets of holes 1006 can allow adhesive that is applied at one side of foot 800 to flow to the other side and to form a mechanical lock extending from one side of the concrete groove 702 to the other side of the concrete groove. Additionally, or alternatively, the chambers 1008 can act to locate adhesive and to increase surface area for bonding. Additionally, or alternatively the angled pieces (tabs) on the ends 1010 can act as dams so as to facilitate adhesive staying in the desired location when it is deposited rather than spilling beyond the ends of tracker foot plate 802.

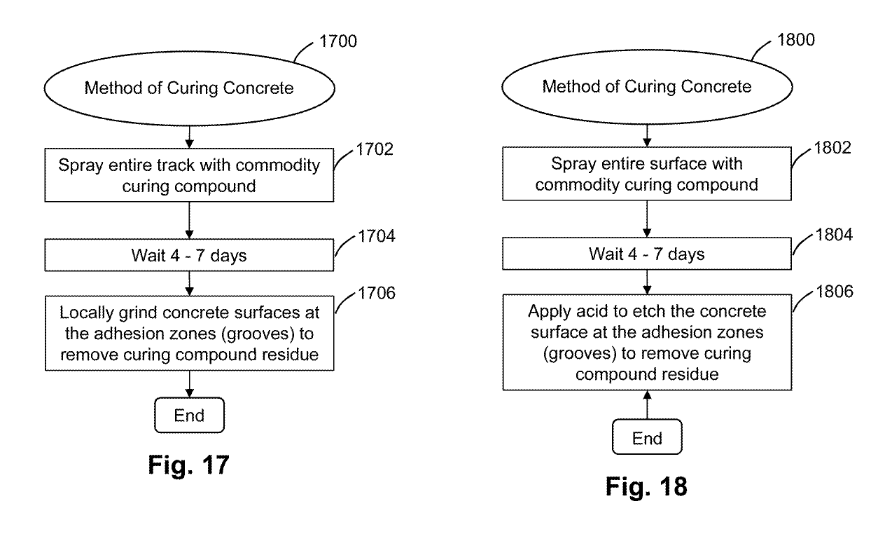

Any number of concrete groove cross-section shapes can be used for the concrete grooves 108 in FIGS. 1 and 702 in FIG. 7. For example, FIGS. 11A-11E schematically illustrate cross-sections of different exemplary concrete groove configurations. FIG. 11A illustrates a configuration including a square-cross-section groove 1104 located in a concrete track 1102. Alternatively, the groove can have a rectangular cross-section and can be deep and narrow such as the groove 1106 in FIG. 11B, or the groove can be shallow and wide as in the groove 1108 in FIG. 11C. The groove alternatively can be trapezoidal in shape, as in the groove 1110 illustrated in FIG. 11D. A semicircle can also be used for the groove cross section, such as in the groove 1112 illustrated in FIG. 11E. Any feet provided herein suitably can be used in combination with any such grooves so as to form joints.

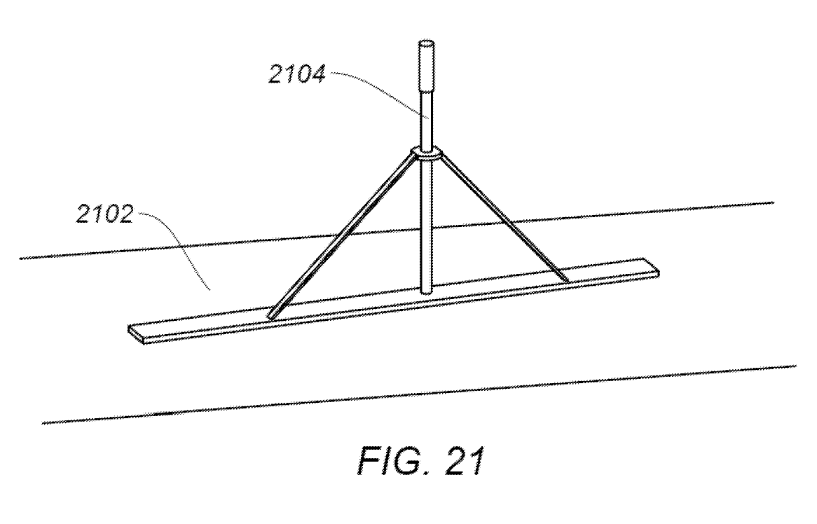

Additionally, any suitable method can be used for installing a solar collector so as to form joints between concrete and a foot. For example, a concrete track including a groove can be slip-formed and then cured, for example using methods such as described with reference to FIGS. 13-20 and 22. A foot of a support structure of a solar collector can be placed in the groove. The foot optionally can include at least one of an aperture (e.g., such as described herein with reference to foot 506 of FIGS. 6-7 or foot 800 of FIGS. 8-10) and a tab (e.g., such as described herein with reference to foot 110 of FIGS. 1-4C). Adhesive can be applied between the foot and the groove such that the adhesive flows through the aperture (e.g., such as described herein with reference to foot 506 of FIGS. 6-7 or foot 800 of FIGS. 8-10) or around the tab (e.g., such as described herein with reference to foot 110 of FIGS. 1-4C). The adhesive mechanically locks the foot of the structure into the groove via the aperture or tab, e.g., such as respectively described herein with reference to 6-7 and 8-10 or FIGS. 1-4C. In some configurations, the foot can include a back wall, a first side wall including the tab, a second side wall including a second tab, a third side wall, a fourth side wall, and a bottom wall, e.g., such as described herein with reference to FIGS. 1-4C. Optionally, an upper surface of the adhesive flows above the tab and the second tab. In some configurations, the foot can include a sheet having the aperture provided therethrough, e.g., such as described herein with reference to FIGS. 6-7 and 8-10. The adhesive can be applied between a first side of the sheet and the groove, and can flow through the aperture to a location between a second side of the sheet and the groove. The foot optionally further can include a chamber and a second aperture provided through the chamber the adhesive can fill the chamber and flow through the second aperture to the second side of the sheet, e.g., such as described herein with reference to FIGS. 6-7 and 8-10.

In some configurations, a concrete track can be formed using steps including slip-forming a concrete track including a groove, and curing the concrete track. Curing the concrete track can include maintaining wetness of the concrete track for a sufficient period of time after slip-forming the concrete track, e.g., in a manner such as described herein with reference to FIGS. 13-20 and 22. Maintaining wetness can include repeatedly spraying water on the concrete track or on a permeable blanket over the concrete track over the sufficient period of time, e.g., such as respectively described herein with reference to FIGS. 14 and 16. Maintaining wetness can include covering a surface of the concrete track with a vapor-impermeable membrane for the sufficient period of time, e.g., such as described herein with reference to FIG. 15. Maintaining wetness can include spraying the entire concrete track with a curing compound, and the method can include removing residue from the curing compound from at least a portion of the groove at which the adhesive is to be applied, e.g., such as described herein with reference to FIGS. 17 and 18. The method can include applying a mask to at least a portion of the groove at which the adhesive is to be applied, wherein said maintaining wetness can include spraying the concrete track with the mask applied thereto with a first curing compound; removing the mask to expose at least the portion of the groove; and spraying the exposed at least the portion of the groove with a second curing compound, e.g., such as described herein with reference to FIGS. 20-22.

The sufficient period of time optionally can be four to seven days. Optionally, the concrete track includes a first track including the groove and a second track including a second groove, the first and second tracks being parallel to one another in spaced relation, e.g., such as described herein with reference to FIG. 5. Optionally, the method also can include installing control joints along the concrete track, e.g., such as described herein with reference to FIG. 1.

Any suitable combination of such steps can be used to form a concrete track and/or install a solar collector. For example, a method for installing a solar collector can include slip-forming a concrete track including a groove; curing the concrete track, wherein curing the concrete track comprises maintaining wetness of the concrete track for a sufficient period of time after slip-forming the concrete track; placing a foot of a support structure of a solar collector in the groove; and applying adhesive between the foot and the groove such that the adhesive surrounds the foot.

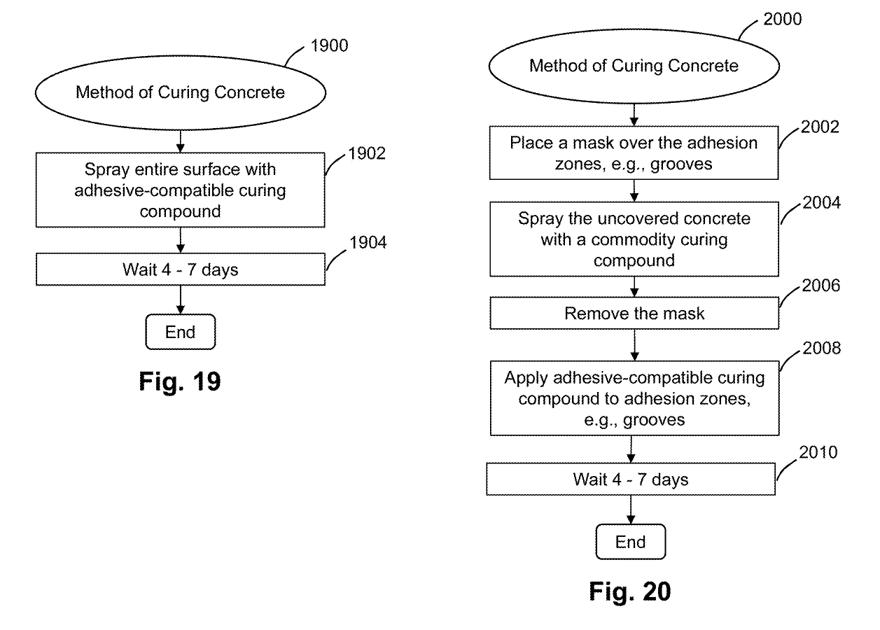

FIG. 12 illustrates an exemplary flow of steps in a method 1200 for installing a solar collector on a concrete track. First, a concrete track with grooves is created by slip-forming (1202). In some configurations, step 1202 includes slip-forming two parallel tracks at once so as to accommodate opposite feet for solar collectors. Additionally, control joints can be installed (1204). Additionally, the concrete can be cured (1206) (note that step 1204 optionally can be performed after step 1206). Additionally, the support structure (e.g., a fixed tilt support structure such as described above with reference to FIG. 1 or a tracking support structure such as described above with reference to FIG. 5) can be placed on the concrete track or tracks with the feet located in the grooves (1208). Step 1208 can include assembling a solar collector and then placing it onto the concrete track and/or can include placing part of the support structure on the concrete track and then assembling the rest of the solar collector in place. Additionally, adhesive can be applied in the grooves at the location of the feet such that adhesive flows to both sides of the feet from one wall of the groove to the other (1210).

Installing the control joints in the concrete track (1204) can help to inhibit or prevent cracks between the control joints which can lead to inadequate ballast at some locations. The control joints can be spaced so as to provide adequate ballast to each foot. Control joints are installed with a saw or blade while the concrete is still fresh. Optionally, the adhesive is colored so as to facilitate confirmation as to whether the adhesive sufficiently fills the gap between the groove walls and the foot at the appropriate location(s).

Curing the concrete track (1206) optionally can include ensuring that sufficient water is available after the concrete has been formed for a sufficient period of time after formation, e.g., for period of approximately four to seven days, so that chemical reactions can take place to increase the strength of the concrete. Curing can be performed in such a manner as to provide sufficient, e.g., maximum, concrete strength in the vicinity of the foot joints, to provide sufficient concrete strength in the bulk volume of the concrete, to provide sufficient adhesion between the concrete surface and the adhesive to delay shrinkage and associated cracks until the concrete has gained sufficient strength, and to reduce, e.g., minimize, cost. The curing process can assist in developing surface strength in the grooves, concrete strength around the grooves, and strength in the bulk of the material to inhibit or resist shrinkage cracks. A variety of methods can be used to cure the concrete track.

For example, FIGS. 13-20 and 22 illustrate exemplary flows of steps in different methods for curing concrete, such as slip-formed concrete tracks or concrete tracks formed using another suitable method. In the exemplary method 1300 illustrated in FIG. 13, if sufficient humidity is present in the ambient air, the curing method includes allowing the humid air ambient conditions to ensure the concrete retains water (1302), and waiting a sufficient amount of time (1304), e.g., four to seven days, for curing to take place. In this method, sufficient water is present when the concrete is formed, and since the air is humid, very little evaporation takes place.

In the exemplary method 1400 illustrated in FIG. 14, an alternative method of curing concrete tracks is to repeatedly spray water on the concrete, e.g., once or twice per day, for a sufficient amount of time (1402), e.g., for a period of four to seven days, for curing to take place. Such water can be sprayed, for example, from water trucks that drive around the installation site.

In the exemplary method 1500 illustrated in FIG. 15, another method of curing concrete tracks can include covering the entire concrete surface immediately after slip-forming with a vapor-impermeable membrane, such as plastic sheeting, to retain water (1502) and then waiting a sufficient amount of time (1504), e.g., four to seven days, for curing to take place. The vapor-impermeable membrane can inhibit or prevent evaporation. The membrane then can be removed (1506). Alternatively, only a portion of the concrete surface can be covered with a vapor-impermeable membrane at operation 1502. For example, at operation 1502 optionally only the groove can be covered with a vapor-impermeable membrane, such as a foam bead, and the remainder of the concrete surface left exposed.

In the exemplary method 1600 illustrated in FIG. 16, another method of curing concrete tracks includes to spray water on the concrete (1602), covering the entire concrete surface with a permeable blanket, such as burlap sacks (1604), spraying water intermittently on the permeable blanket for a suitable amount of time (1606), e.g., for four to seven days, as necessary to keep the concrete surface wet, and then to remove the covers (1608).

In the exemplary method 1700 illustrated in FIG. 17, another method of curing the concrete tracks includes spraying the entire surface with a standard curing compound (1702), and then waiting a sufficient amount of time (1704), e.g., four to seven days. For example, standard curing compounds can include resins and waxes that can inhibit or prevent evaporation of water from the concrete. However, residue left from the curing compound potentially can interfere with adhesion of the adhesive used to secure the solar collector feet to the concrete surface. Method 1700 optionally can include grinding the concrete surfaces at the adhesion zones (e.g., grooves) of the concrete tracks so as to remove curing compound residue (1706).

The exemplary method 1800 illustrated in FIG. 18 is similar to that of FIG. 17, e.g., includes spraying the entire surface with a standard curing compound (1802) and waiting a sufficient amount of time (1804). However, instead of grinding the concrete surface at the adhesion zones, an acid instead is used to etch the concrete surface at the adhesion zones (e.g., grooves) so as to remove the curing compound residue (1806).

While some curing compounds leave a residue that interferes with adhesion of the adhesive, a curing compound that does not leave such a residue is used in the exemplary method 1900 illustrated in FIG. 19. An adhesive-compatible curing compound is applied to the entire concrete surface (1902), and then the concrete is allowed to cure for a sufficient amount of time (1904), such as four to seven days.

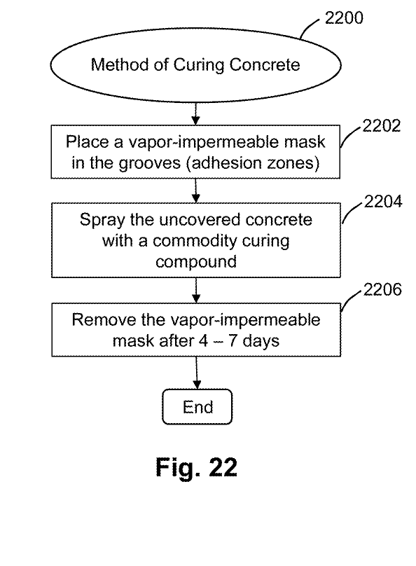

In the exemplary method 2000 illustrated in FIG. 20, a mask is temporarily placed over the adhesion zones, e.g., grooves (2002). A standard curing compound is sprayed on the uncovered concrete surfaces (2004). The mask can be removed (2006). An adhesive-compatible curing compound is applied to the zones where adhesion is to take place, e.g., the grooves (2008). The concrete is allowed to cure for a sufficient amount of time (2010), such as four to seven days. Note that in method 2000, any suitable number of curing compounds, such as two different curing compounds, can be used for cost savings since the adhesive-compatible curing compound can be more expensive than the standard curing compound. FIG. 21 schematically illustrates an exemplary mask that can be used during operation 2002 of the method of FIG. 20. In this configuration, the mask can be a hand-held tool that includes a mask head 2102 and a handle 2104. A worker can place the mask head 2102 in the concrete track groove while spraying the nearby concrete with standard curing compound. Another example mask is a flexible strip attached behind the slip forming machine that is dragged along as the slip forming machine moves. Other masks suitably can be used.

In the exemplary method 2200 illustrated in FIG. 22, a vapor-impermeable mask is placed in the adhesion zones (e.g., grooves) (2202). This mask can be or include a continuous foam rod such as a sealant-baked rod compressed to fit in the grooves, such as grooves 108 in the concrete track 102 illustrated in FIG. 1. A commodity curing compound can be sprayed on the uncovered concrete surface (2204). The vapor-impermeable mask can inhibit or prevent the commodity curing compound from covering the adhesion zone, and also can retain water around the adhesion zone for curing. A sufficient time, e.g. four to seven days, is allowed for the concrete to cure (2206).

In one nonlimiting example, a method for installing a solar collector is provided. The method can include slip-forming a concrete track including a groove; curing the concrete track; placing a foot of a support structure of a solar collector in the groove, the foot including at least one of an aperture and a tab; and applying adhesive between the foot and the groove such that the adhesive flows through the aperture or around the tab. Examples of such a method are provided herein with reference to FIGS. 1-3, 4A-4C, 5-7, 8-10, 11A-11E, 12, and 13-22.

In another nonlimiting example, a foot of a support structure of a solar collector is provided. The foot can be configured to be inserted into a groove and including a back wall, a first side wall including a first side tab, a second side wall including a second side tab, a third side wall, a fourth side wall, and a bottom wall. Examples of such a foot are provided herein with reference to FIGS. 2-3.

In another nonlimiting example, a foot of a support structure of a solar collector is provided. The foot can be configured to be inserted into a groove and can include a sheet including a lower edge and first and second ends, a chamber, a first plurality of apertures through the sheet, and tabs disposed at the first and second ends. Examples of such a foot are provided herein with reference to FIGS. 5-10.

In another nonlimiting example, a method for installing a solar collector is provided. The method can include slip-forming a concrete track including a groove; curing the concrete track, wherein curing the concrete track includes maintaining wetness of the concrete track for a sufficient period of time after slip-forming the concrete track; placing a foot of a support structure of a solar collector in the groove; and applying adhesive between the foot and the groove such that the adhesive surrounds the foot. Examples of such a method are provided herein with reference to FIGS. 12 and 13-22.

In still another nonlimiting example, a joint is provided. The joint can include a foot of a solar collector, the foot comprising at least one of an aperture and a tab; a concrete track comprising a groove, the foot being disposed in the groove; and adhesive disposed between the foot and the groove such that the adhesive extends through the aperture or around the tab. Examples of such a joint are provided herein with reference to FIGS. 1, 3, 5, 7, and 9-10.

While various illustrative embodiments of the invention are described herein, it will be apparent to one skilled in the art that various changes and modifications may be made therein without departing from the invention. For example, the present systems and methods are not limited to use with photovoltaic modules, and instead can be applied to solar collectors including any type of solar module (e.g., a module such as used with a concentrated solar power system, such as a parabolic trough or heliostat), or to creating joints between concrete and any other type of structure. The appended claims are intended to cover all such changes and modifications that fall within the true spirit and scope of the invention.

1. A method for installing a solar collector, the method comprising:
slip-forming a concrete track including a groove;
curing the concrete track;
placing a foot of a support structure of a solar collector in the groove, the foot comprising at least one of an aperture and a tab; and
applying adhesive between the foot and the groove such that the adhesive flows through the aperture or around the tab.

2. The method of claim 1, wherein the adhesive mechanically locks the foot of the support structure into the groove via the aperture or tab.

3. The method of claim 1, wherein the foot comprises a back wall, a first side wall including the tab, a second side wall including a second tab, a third side wall, a fourth side wall, and a bottom wall.

4. The method of claim 3, wherein an upper surface of the adhesive flows above the tab and the second tab.

5. The method of claim 1, wherein:
the foot comprises a sheet having the aperture provided therethrough;
the adhesive is applied between a first side of the sheet and the groove; and
the adhesive flows through the aperture to a location between a second side of the sheet and the groove.

6. The method of claim 5, wherein the foot further comprises a chamber and a second aperture provided through the chamber; and
the adhesive fills the chamber and flows through the second aperture to the second side of the sheet.

7. The method of claim 1, wherein curing the concrete track comprises maintaining wetness of the concrete track for a sufficient period of time after slip-forming the concrete track.

8-10. (canceled)

11. The method of claim 7, further comprising applying a mask to at least a portion of the groove at which the adhesive is to be applied, wherein said maintaining wetness comprises:
spraying the concrete track with the mask applied thereto with a first curing compound;
removing the mask to expose at least the portion of the groove; and
spraying the exposed at least the portion of the groove with a second curing compound.

12-14. (canceled)

15. A foot of a support structure of a solar collector, the foot configured to be inserted into a groove and comprising a back wall, a first side wall including a first side tab, a second side wall including a second side tab, a third side wall, a fourth side wall, and a bottom wall.

16-20. (canceled)

21. A foot of a support structure of a solar collector, the foot configured to be inserted into a groove and comprising a sheet including a lower edge and first and second ends, a chamber, a first plurality of apertures through the sheet, and tabs disposed at the first and second ends.

22. (canceled)

23. A method for installing a solar collector, the method comprising:
slip-forming a concrete track including a groove;
curing the concrete track,
wherein curing the concrete track comprises maintaining wetness of the concrete track for a sufficient period of time after slip-forming the concrete track;
placing a foot of a support structure of a solar collector in the groove; and
applying adhesive between the foot and the groove such that the adhesive surrounds the foot.

24. The method of claim 23, wherein said maintaining wetness comprises repeatedly spraying water on the concrete track or on a permeable blanket over the concrete track over the sufficient period of time.

25. The method of claim 23, wherein said maintaining wetness comprises covering a surface of the concrete track with a vapor-impermeable membrane for the sufficient period of time.

26. The method of claim 23, wherein said maintaining wetness comprises spraying the entire concrete track with a curing compound, the method further comprising removing residue from the curing compound from at least a portion of the groove at which the adhesive is to be applied.

27. The method of claim 23, further comprising applying a mask to at least a portion of the groove at which the adhesive is to be applied, wherein said maintaining wetness comprises:
spraying the concrete track with the mask applied thereto with a first curing compound;
removing the mask to expose at least the portion of the groove; and
spraying the exposed at least the portion of the groove with a second curing compound.

28-29. (canceled)

30. The method of claim 23, further comprising installing control joints along the concrete track.

31. The method of claim 23, wherein the adhesive is colored so as to facilitate confirmation as to whether the adhesive completely surrounds the foot.

32. A joint comprising:
a foot of a solar collector, the foot comprising at least one of an aperture and a tab;
a concrete track comprising a groove, the foot being disposed in the groove; and
adhesive disposed between the foot and the groove such that the adhesive extends through the aperture or around the tab.

33. The joint of claim 32 wherein the adhesive mechanically locks the foot of the support structure into the groove via the aperture or tab.

34. The joint of claim 32, wherein the foot comprises a back wall, a first side wall including the tab, a second side wall including a second tab, a third side wall, a fourth side wall, and a bottom wall.

35. The joint of claim 32, wherein the foot comprises a sheet including a lower edge and first and second ends, a chamber, a first plurality of apertures through the sheet, and tabs disposed at the first and second ends.

36. The joint of claim 32, wherein the joint is formed using the method of claim 23.
